(19) United States
(12) Patent Application Publication
(10) Pub. No.: US 2025/0381542 A1
(43) Pub. Date: Dec. 18, 2025

(54) Systems and Methods for Continuous Carbonization Processes

(71) Applicant: Paebbl AB, Stockholm (SE)

(72) Inventors: Paulus Saari, Stockholm (SE); Louk Eskens, Stockholm (SE); Floris Degener, Stockholm (SE)

(21) Appl. No.: 18/879,420

(22) PCT Filed: Jun. 30, 2023
(86) PCT No.: PCT/SE2023/050680

§ 371 Date: Dec. 27, 2024

(30) Foreign Application Priority Data
Jul. 1, 2022 (SE) 2250833-7

(51) Int. Cl. B01J 8/18; B01J 3/00; B01J 3/02; B01J 8/00; B01J 8/08; B01J 8/22; C01F 5/24

(52) U.S. Cl. CPC B01J 8/1827; B01J 3/008; B01J 3/02; B01J 8/0015; B01J 8/0055; B01J 8/087; B01J 8/1809; B01J 8/1836; B01J 8/226; C01F 5/24; B01J 2208/00176; B01J 2208/0061; B01J 2208/00769

(57) ABSTRACT

A system and a method for carbonization processes, and to a loop reactor arrangement for such processes. A loop reactor arrangement according to the invention includes a slurry inlet, at least one elongated reactor, at least one pump, at least one continuous separator, and a CO₂ inlet. The elongated reactor and the continuous separator form a loop.

### CROSS-REFERENCE TO RELATED APPLICATIONS

This application is the United States national phase of International Patent Application No. PCT/SE2023/050680 filed Jun. 30, 2023, and claims priority to Swedish Patent Application No. 2250833-7 Jul. 1, 2022, the disclosures of which are hereby incorporated by reference in their entireties.

### BACKGROUND OF THE INVENTION

### Field of the Invention

The present invention relates to system and methods for carbonization processes, as well as to reactor arrangements for such processes.

### Description of Related Art

Global warming and climate change that is due to the emission of greenhouse gases from humans is a growing problem. One way to counteract global warming is to accelerate the naturally occurring carbonization of magnesium silicates, such as olivine or other (ultra)mafic minerals. The carbonization of olivine results in the formation of magnesium carbonate and silicon dioxide that both are stable and can be stored indefinitely without any release of CO₂. Even though the conversation of olivine to magnesium carbonate and silicon dioxide is a natural process it is a very slow process. Therefore, there is a need to increase the reaction rate and industrially implement the process. Increasing the reaction rate can be performed using different techniques such as particle size reduction, heat, increased pressure etc.

‘Carbon dioxide sequestration by aqueous mineral carbonation of magnesium silicate minerals’ by S. J. Gerdemann et al. Journal Volume: I:, Conference: 2^{nd} Annual Conference on Carbon Sequestration, Alexandria, VA, May 5-8, 2003, discloses ways of accelerating carbonation of the magnesium silicate minerals olivine and serpentine.

In the prior art there is a need for a reactor for energy efficient carbonization of minerals, such as olivine.

### SUMMARY OF THE INVENTION

An objective of the present invention is to provide a system, a reactor arrangement and a method for carbonization of (ultra)mafic minerals.

This is and other objectives are met by the reactor arrangement, the system, and the method of the present invention.

The present invention is defined in the independent claims. Further embodiments of the invention are defined by the dependent claims.

A first aspect of the invention relates to a loop reactor arrangement for a continuous carbonization process. The loop reactor arrangement comprises an elongated reactor comprising a reactor outlet opening, a reactor inlet opening and at least one carbon dioxide (CO₂) inlet for gaseous and/or supercritical CO₂. The loop reactor arrangement also comprises a slurry inlet for continuous flow of slurry into the elongated reactor, at least one pump and at least one continuous separator. The continuous separator comprises a continuous separator inlet opening in fluid communication with the reactor outlet opening and a continuous separator outlet opening in fluid communication with the reactor inlet opening. The loop reactor arrangement also comprises a slurry outlet. The elongated reactor and the particle continuous separator form a loop and the at least one pump is arranged to pump at least a portion of the slurry at least one lap through the loop. The continuous separator is arranged to continuously separate at least a part of the particles with a particle size smaller than a first predetermined particle size from the loop reactor arrangement.

In one embodiment of the invention, the elongated reactor additionally comprises at least one CO₂ sensor and at least one CO₂ control unit. The CO₂ control unit is arranged to control the CO₂ level in the elongated reactor.

In one embodiment of the invention, the CO₂ control unit is arranged to control inlet of gaseous and/or supercritical CO₂ through the at least one CO₂ inlet based on an output signal generated by the at one CO₂ sensor and representative of a CO₂ level in the elongated reactor.

In one embodiment of the invention, the continuous separator comprises a hydrocyclone.

In one embodiment of the invention, the loop reactor arrangement comprises a cooler device in fluid communication with the slurry outlet.

In one embodiment of the invention, the loop reactor arrangement comprises at least one temperature regulating device arranged to heat or cool the elongated reactor.

In one embodiment of the invention, the gas pressure of CO₂ inside the elongated reactor varies 10% or less during use of the loop reactor arrangement.

In one embodiment of the invention, the loop reactor arrangement further comprises a large particle separator arranged to separate large particles with a particle size larger than a third predetermined particle size. The third predetermined particle size is larger than the first predetermined particle size.

A second aspect of the invention relates to a carbonization system comprising two or more loop reactor arrangements according to above. The two or more loop reactor arrangements are arranged in a sequence so that a first loop reactor arrangement of the two or more loop reactor arrangements is arranged upstream a second loop reactor arrangement of the two or more loop reactor arrangements. The two or more loop reactor arrangements are in fluid communication with each other.

In one embodiment of the invention, the slurry outlet of the first loop reactor arrangement is in fluid communication with the slurry inlet of the second loop reactor arrangement.

A third aspect of the invention relates to a method for carbonizing minerals using a loop reactor arrangement according to above, or a carbonization system according to above. The method comprises the steps of forming a first slurry comprising mineral particles and water, continuously feeding the first slurry to the elongated loop reactor allowing the mineral particles to react with dissolved CO₂, and flowing the first slurry through the elongated reactor, in which CO₂ is dissolved in a liquid of the slurry. The method also comprises separating particles having a particle size below a first predetermined particle size of the first slurry from the elongated loop reactor using the continuous separator. The method optionally comprises flowing the separated particles into a second loop reactor arrangement of the carbonization system in the form of a second slurry, and separating particles having a particle size below a second predetermined particle size of the second slurry from the elongated reactor of the second loop reactor arrangement using the continuous separator of the second loop reactor arrangement. The method further comprises cooling the slurry exiting the elongated reactor.

One advantage of the invention is that due to the loop construction, the loop reactor arrangement does not require multiple injection points of CO₂ through the elongated reactor. CO₂ can instead be continuously added to the reaction since it stays in the elongated reactor for several laps.

One advantage with the invention is that it allows for a cost effective and scalable process.

One advantage with the invention is that allows for a high flow rate, which enables particles to stay in the suspension and not sink to the bottom. When particles stay in the suspension it is more likely that they have some mechanical interaction, which is beneficial.

One advantage with a loop reactor arrangement according to the invention is that a broad particle size distribution can be used in the carbonization process. This is possible since reacted smaller particles are continuously removed from the elongated reactor.

One advantage with two or more loop reactor arrangements that are in fluid communication with each other is that the particles are allowed to react with the CO₂ in at least two elongated reactors potentially leading to a more complete carbonization process, or in a more complete conversion and a more even quality of the output material.

It is an advantage with the invention that the CO₂ can be more evenly distributed when the slurry flows more than one lap through the elongated reactor.

In the following, the invention will be described in more detail, by way of example only, with regard to non-limiting embodiments thereof, reference being made to the accompanying drawings.

### BRIEF DESCRIPTION OF THE DRAWINGS

The terms Fig., Figs., Figure, and Figures are used interchangeably in the specification to refer to the corresponding figures in the drawings.

The embodiments, together with further objectives and advantages thereof, may best be understood by making reference to the following description taken together with the accompanying drawings, in which:

FIG. 1 is a schematic illustration of a loop reactor arrangement according to an embodiment of the invention;

FIG. 2 is a schematic illustration of a carbonization system according to an embodiment of the invention;

FIG. 3 is a schematic illustration of a carbonization system according to another embodiment of the invention;

FIG. 4 is a schematic illustration of a loop reactor arrangement according to an embodiment of the invention; and

FIG. 5 is a flow-chart according to an embodiment of the invention.

### DESCRIPTION OF THE INVENTION

Terms such as “top”, “bottom”, upper “, lower”, etc are used merely with reference to the geometry of the embodiments of the invention shown in the drawings and are not intended to limit the invention in any manner.

As described in the background there is a need for systems and reactor arrangements for energy-efficient carbonization of minerals such as olivine (Mg₂SiO₄), serpentine ((Mg,Fe)₃Si₂O₅(OH)₄), wollastonite (CaSiO₃), and/or nickel laterite (Fe,Ni)O(OH)·xH₂O). Additionally, other minerals or materials can be used such as alkaline residual materials, asbestos materials, etc. The general chemical reaction of carbonization of olivine is:

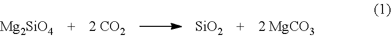

Magnesium carbonate (MgCO₃) is more thermodynamically stable than olivine (MgSiO₄). However, in nature both magnesium carbonate and olivine occur frequently telling us that reaction (1) above is very slow and not on a timescale relevant for carbon dioxide sequestering. Therefore, in order to industrially implement processes using reaction (1) for CO₂ storage there is a need for increasing the reaction rate. However, for the CO₂ storage to be environmentally friendly the increase in reaction rate has to be done in an energy efficient way.

A first aspect of the invention relates to a loop reactor arrangement 100; 200 for a continuous carbonization process. The loop reactor arrangement 100; 200 comprises an elongated reactor 110; 210 comprising a reactor outlet opening 110′; 210′, a reactor inlet opening 110″; 210″ and at least one CO₂ inlet 130; 230 for gaseous and/or supercritical CO₂. The loop reactor arrangement 100; 200 also comprises a slurry inlet 120; 220 for continuous flow of slurry into the elongated reactor 110; 210, at least one pump 170; 270 and at least one continuous separator 150; 250. The continuous separator 150; 250 comprises a continuous separator inlet opening 150′; 250′ in fluid communication with the reactor outlet opening 110′; 210′ and a continuous separator outlet opening 150″; 250′ in fluid communication with the reactor inlet opening 110″; 210″. The loop reactor arrangement 100; 200 further comprises a slurry outlet 160; 260.

Hence, the reactor outlet opening 110′; 210′ is in fluid communication with the continuous separator inlet opening 150′; 250′, and the continuous separator outlet opening 150″; 250″ is in fluid communication with the reactor inlet opening 110″; 210″. In this way the elongated reactor 110; 210 and the particle continuous separator 150; 250 form a loop 100′; 200′. The loop 100′; 200′ may be continuous so that a slurry can continuously flow through the elongated reactor 110; 210 and the continuous separator 150; 250 at least one lap.

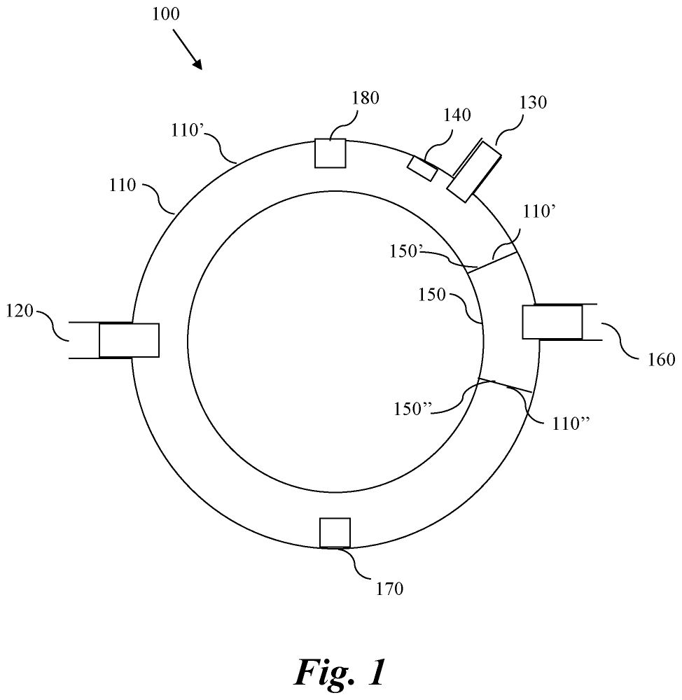

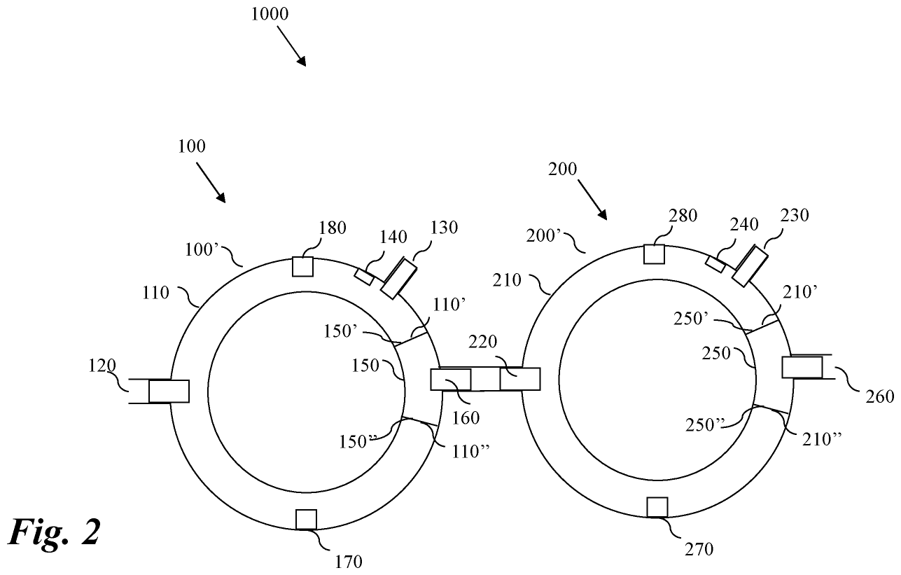

The pump 170; 270 is arranged to pump at least a portion of the slurry at least one lap through the loop 100′; 200′. The continuous separator 150; 250 is arranged to continuously separate at least part of the particles with a particle size smaller than a first predetermined particle size from the loop reactor arrangement 100; 200. Such a reactor is schematically illustrated in FIGS. 1 and 2.

In an embodiment, the elongated reactor 110; 210 additionally comprises at least one CO₂ sensor 140; 240, such as at least one CO₂ gas sensor 140; 240, and at least one CO₂ control unit 180; 280. The CO₂ control unit 180; 280 is, in this embodiment, arranged to control the CO₂ level in the elongated reactor 110; 210.

In a particular embodiment, the CO₂ control unit 180; 280 is arranged to control inlet of gaseous CO₂ through the at least one CO₂ inlet 130; 230 based on an output signal generated by the at least one CO₂ gas sensor 140; 240, such as the at least one CO₂ gas sensor 140; 240, and representative of a CO₂ level in the elongated reactor 110; 210.

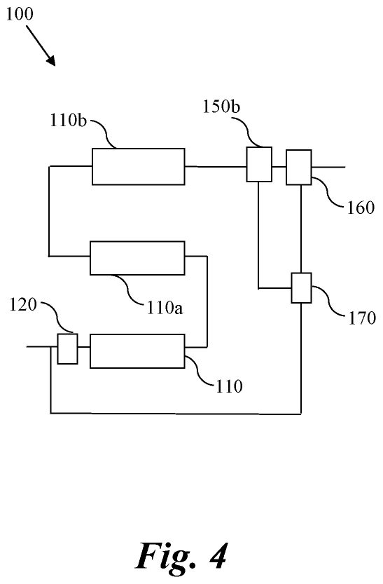

In one embodiment, the slurry outlet 160; 260 is in fluid communication with the pump 170; 270. Such an embodiment is schematically illustrated in FIG. 4. FIG. 4 is discussed in more detail further down.

The slurry inlet 120; 220 is arranged to receive a slurry that typically comprises olivine or another or other (ultra)mafic mineral(s) and water. (Ultra)mafic mineral as used herein include mafic minerals (silica content typically between 45 and 55 weight percentage (wt %) and ultramafic minerals (silica content typically less than 45 weight percentage). A mafic mineral is a silicate mineral or igneous rock rich in magnesium and iron. Common mafic minerals include olivine, pyroxene, amphibole, and biotite. The slurry may additionally comprise additives, for example oxygen, or other reducing agents, or acids, such as oxalic acid, ascorbic acid or similar. The slurry inlet 120; 220 is in communication with or connected to the elongated reactor 110; 210. The slurry typically comprises an excess of water in relation to solids, such as e.g., 10-50 wt %, preferably 30-40 wt % solids. The solids may be pre-treated before entering the loop reactor arrangement 100; 200, for example by grinding to reduce the particle size. The particles that enter the slurry inlet 120; 220 are generally 5-200 μm in particle size or 10-100 μm in particle size. The loop reactor arrangement 100; 200 is arranged to run a continuous process, therefore the slurry inlet 120; 220 is arranged to continuously receive slurry. The loop reactor arrangement 100; 200 is arranged to flow the slurry through the loop 100′; 200′, i.e., through the elongated reactor 110; 210 and the continuous separator 150; 250 at least one time, or one lap.

In one embodiment of the invention, the water and/or additives used in the loop reactor arrangement 100; 200 are at least partly recycled.

The elongated reactor 110; 210 is arranged to provide a reactor for reaction (1) above, or any other reaction wherein a mineral or mixture of minerals is carbonized. When slurry flows through the elongated reactor 110; 210 it reacts with the CO₂ that dissolves in the liquid, such as water, of the slurry. In the case that the slurry comprises olivine it will form magnesium carbonate and silicon dioxide during the reaction, according to reaction (1) above. The particle size generally decreases during the reaction. In order to remove reacted particles from the elongated reactor 110; 210, the loop reactor arrangement 100; 200 comprises a continuous separator 150; 250. The continuous separator 150; 250 is arranged to separate particles from the loop reactor arrangement 100; 200 that has an average particle size that is smaller than the first predetermined particle size. The first predetermined particle size may be the average particle size of the slurry that enters the elongated reactor 110; 210, or a smaller average particle size. In one embodiment, the particle size of particles entering the elongated reactor 110; 210 is 5-200 μm, or 10-100 μm, or 50-100 μm. In an embodiment, the first predetermined particle size is smaller than the average particle size of the particles in the slurry that enters the elongated reactor 110; 210. For instance, the first predetermined particle size could be selected within a range of 5-20 μm, such as 5-15 μm or about 10 μm. Generally, the size of the particles output from the loop reactor arrangement 100; 200 is typically smaller than the average of the particle size distribution of the particles input into the loop reactor arrangement 100; 200.

In one embodiment, the continuous separator 150; 250 is a hydrocyclone. Other examples of continuous separators 150; 250 include centrifuges, decanter, shear induced diffusion, and ratchet design. The continuous separator 150; 250 is arranged in fluid communication with the elongated reactor 110; 210, as illustrated in FIGS. 1 and 2. The continuous separator 150; 250 may be arranged to separate particles below the first predetermined particle size.

It is possible that the slurry comprises large particles that are essentially inert. There is a risk that such large particles continue to circulate through the loop reactor arrangement 100; 200 and eventually clog the loop reactor arrangement 100; 200. Therefore, in one embodiment of the invention, the loop reactor arrangement 100; 200 further comprises a large particle separator (not shown). Such large particle separator can be arranged upstream the slurry inlet 120; 220. It may also be arranged inside loop reactor arrangement 100; 200 or at any other suitable position. The aim of a large particle separator is, thus, to separate large, inert particles from the slurry and thereby reducing the risk of clogging the loop reactor arrangement 100; 200. In an embodiment, the large particle separate is arranged to separate large particles with a particle size larger than a third predetermined particle size. The third predetermined particle size is larger than the above-mentioned first predetermined particle size.

The loop reactor arrangement 100; 200 is arranged to run a continuous process wherein slurry continuously enters the elongated reactor 110; 210 at the slurry inlet 120; 220, flows at least one lap through the elongated reactor 110; 210, and when a particle in the slurry has reached a particle size that is smaller than the first predetermined particle size it is separated by the continuous separator 150; 250 and exits the loop reactor arrangement 100; 200 at the slurry outlet 160; 260. Not all particles below a predetermined size have to be separated at the same time. It is possible that part of the particles below the first predetermined size continues one or more extra laps in the loop reactor arrangement 100; 200 before being separated.

The CO₂ control unit 180; 280 is arranged to control the CO₂ level inside the elongated reactor 110; 210. It is preferably arranged to control the CO₂ level so that there is an excess of CO₂ present in the elongated reactor 110; 210. During use of the elongated reactor 110; 210, the CO₂ will dissolve in the slurry. The dissolved CO₂ will lower the pH of the slurry, which can be beneficial for reaction (1). If there is an excess of CO₂, CO₂ will be present in gaseous or supercritical form as well in the elongated reactor 110; 210. The presence of gaseous CO₂ inside the loop reactor arrangement 100; 200 can be used as an indicator that the liquid inside the loop reactor arrangement 100; 200 is saturated with CO₂.

The elongated reactor 110; 210 may comprise more than one CO₂ sensor 140; 240, such as two, three or four CO₂ sensors. In such a case, the multiple CO₂ sensors 140; 240 could be arranged at different sites along the elongated reactor 100; 210. The CO₂ sensor(s) 140; 240 could be CO₂ gas sensor(s) 140; 240, i.e., configured to detect CO₂ in gaseous form. For instance, the CO₂ gas sensor(s) 140; 240 may be a gas bubble detector or any other type of detector configured to detect the presence of gaseous CO₂. Alternatively, the CO₂ sensor(s) 140; 240 could be CO₂ supercritical sensor(s) 140; 240 arranged to detect CO₂ in supercritical form. It is also possible to use a combination of at least one CO₂ gas sensor and at least one CO₂ supercritical sensor. The CO₂ sensor 140; 240 is arranged to communicate with the CO₂ control unit 180; 280 in order to regulate the gas pressure, and in particular the partial pressure of CO₂, inside the elongated reactor 110; 210. In such way, the gas pressure can be maintained at a level so that during use of the loop reactor arrangement 100; 200 there is an excess of CO₂ present in at least the elongated reactor 110; 210. Hence, the one or more CO₂ sensors 140; 240 are preferably arranged to generate an output signal representative of the CO₂ level, such as partial pressure of CO₂, within the elongated reactor 110; 210. The output signal(s) from the CO₂ sensor(s) 140; 240 is then input to and used by the CO₂ control unit 180; 280 to control the inlet or inflow of gaseous and/or supercritical CO₂ through the at least one CO₂ inlet 130; 230.

CO₂ is arranged to enter the elongated reactor 110; 210 in gaseous form via the CO₂ gas inlet 130; 230. Prior to entering the elongated reactor 110; 210 the CO₂ may be stored in, for example, a tank in liquid form. In such case, the CO₂ may be heated prior to entering the elongated reactor 110; 210. In one embodiment, the CO₂ enters the elongated reactor 110; 210 in a supercritical form. The supercritical state of CO₂ is both temperature and pressure dependent. The temperature and pressure inside the elongated reactor 110; 210 depend on various parameters, such as length, diameter, material, etc as well as of reaction parameters, such as additives, concentration in the slurry etc. Typical temperature values are 150-200° C., e.g., 180° C., and typical pressure values are 50-150 bar, e.g., 100 bar.

Typical dimensions of the elongated reactor 110; 210 is 5-50 cm in diameter and 5-50 m in length. Typical time for a particle in the elongated reactor 110; 210 is 6-60 minutes, during which it will flow through the loop 100′, 200′ several times.

In one embodiment, the loop reactor arrangement 100; 200 comprises more than one elongated reactor, such as a first elongated reactor 110; 210, a second elongated reactor 110a, and a third elongated reactor 110b. In such an embodiment, the elongated reactors 110; 210; 110a; 110b are arranged in sequence and in fluid communication with each other. The first elongated reactor 110; 210 is arranged upstream the second elongated reactor 110a, that is arranged upstream the third elongated reactor 110b. Finally, the third elongated reactor 110b is arranged upstream a continuous separator 150b. Such an embodiment is schematically illustrated in FIG. 4. Upstream and downstream as used herein refer to the flow of slurry through the loop reactor arrangement 100; 200 from the slurry inlet 120; 220 to the slurry outlet 160; 260.

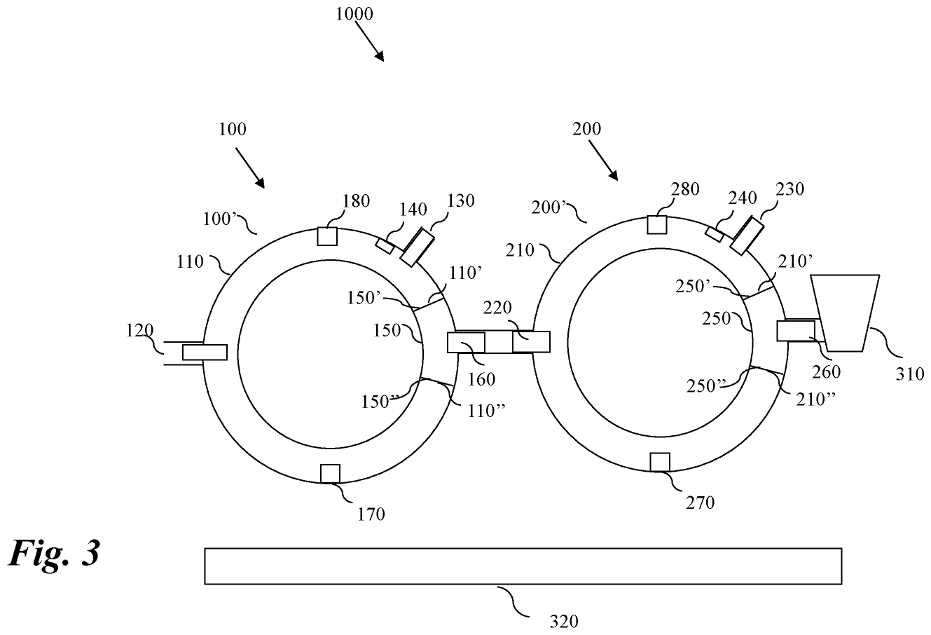

In order to increase the reaction rate, the loop reactor arrangement 100; 200, in particular the elongated reactor 110; 210, may be heated. The heating can be achieved by a temperature regulating device 320 that is arranged in contact with, connected to, or close to, the elongated reactor 110; 210, as illustrated in FIG. 3. Additionally, due to the exothermic nature of the reaction, it may be beneficial to cool the loop reactor arrangement 100; 200. This may additionally be achieved by the temperature regulating device 320. In one example, the loop reactor arrangements 100; 200 may be heated by the temperature regulating device 320 during start in order to reach a predetermined temperature in order to start the reaction. Once the reaction is started the loop reactor arrangements 100; 200 may instead by cooled since the reaction is exothermic and thereby generates heat. The cooling may additionally be performed by the temperature regulating device 320.

Instead of a temperature regulating device 320, a loop reactor arrangement 100; 200 according to the invention may comprise a separate heating device and a separate cooling device. Both the heating device and the cooling device are then arranged in connection to or close to the loop reactor arrangement 100; 200.

Once the particles have reacted with the CO₂ inside the loop reactor arrangement 100; 200, the particles may have a high temperature, in particular if the elongated reactor 110; 210 is heated. Therefore, the loop reactor arrangement 100; 200 may additionally comprise a cooler device 310 arranged downstream the loop reactor arrangement(s) 100; 200 as illustrated in FIG. 3. In one embodiment, the loop reactor arrangement 100; 200 further comprises a cooler device 310 in fluid communication with the particle outlet 160; 260. In such embodiment, the loop reactor arrangement 100; 200 is arranged to cool the particles (slurry) by the cooler device 310 once it exits via the particle outlet 160; 260.

Another aspect of the invention relates to a carbonization system 1000 that comprises two or more loop reactor arrangements 100; 200 in fluid communication with each other. A first loop reactor arrangement 100 of the two or more loop reactor arrangements 100; 200 is arranged upstream a second loop reactor arrangement 200 of two or more loop reactor arrangements 100; 200 as schematically illustrated in FIG. 3.

In an embodiment, the slurry outlet 160 of the first loop reactor arrangement 100 is in fluid communication with the slurry inlet 220 of the second loop reactor arrangement 200.

During use, the carbonization system 1000 is arranged to flow particles in the form of a slurry from the particle inlet 120 of the first loop reactor arrangement 100 to the particle outlet 260 of the second loop reactor arrangement 200 via the first and second loop reactor arrangements 100, 200. The first and the second elongated reactors 110, 210 are preferably arranged to comprise an excess of CO₂ in relation to the amount of particles present in the respective elongated reactor 110; 210. The carbonization system 1000 is arranged to run a carbonization process in the first and second elongated reactors 110, 210 so that the average particle size of particles in the first elongated reactor 110 is typically larger than the average particle size of particles in the second elongated reactor 210. Such a carbonatization system 1000 is schematically illustrated in FIG. 2.

In a carbonization system 1000 according to the invention, all of the elongated reactors 110; 210 preferably comprise an excess of gaseous CO₂. The excess of gaseous CO₂ is beneficial since it is an indication of that the liquid in the slurry, e.g., water, is saturated with CO₂. It is the dissolved CO₂ that can react with the particles in the slurry. Hence, it is advantageous that the liquid is always or almost always saturated with CO₂. Without being bound by any theory, the dissolved CO₂ may serve double purposes by also decreasing the pH, which increases the reaction rate and reacting with the particles. The excess of CO₂ may be in the order of 10%, or 5%, excess in relation to the amount of particles in the slurry.

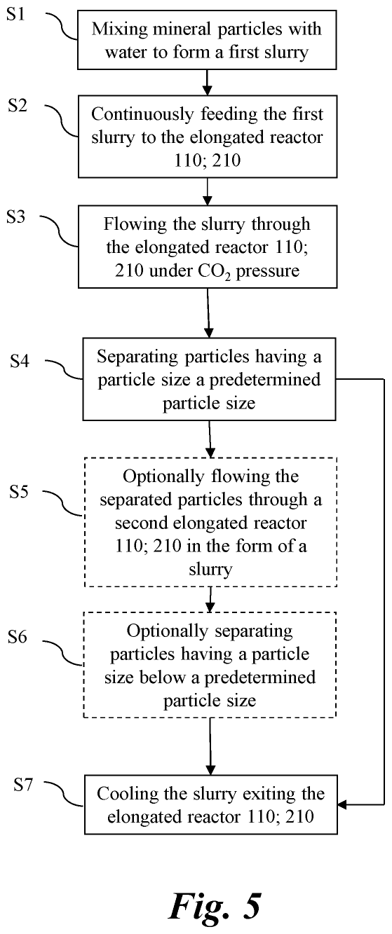

A further aspect of the invention relates to a method for carbonizing minerals, see FIG. 5. The method comprises the steps of:
Slurry formation step S1: Mixing mineral particles with water to form a first slurry. The mineral particles may for example be olivine, and the amount of particles in the slurry may be 10-40 wt %, e.g., 35 wt %;
Feeding step S2: Continuously feeding the first slurry to the elongated reactor 110; 210;
First reaction step S3: Flowing at least a portion of the first slurry through the elongated reactor 110; 210 for at least one lap, in which CO₂ is dissolved in the liquid of the slurry;
First separation step S4: Separating at least part of the particles having a particle size below a first predetermined particle size;
Second reaction step S5: Optionally flowing the separated particles into a second loop reactor arrangement 200 in the form of a slurry;
Second separation step S6: Separating at least part of the particles having a particle size below a second predetermined particle size; and
Cooling step S7: Cooling the slurry exiting the elongated reactor 110; 210.

Such a method is illustrated in the flow chart in FIG. 5.

In an embodiment, the method comprises steps S1-S4 and S7. In such an embodiment, these steps S1-S4 and S7 are performed in a loop reactor arrangement 100; 200 according to the invention.

In another embodiment, the method comprises steps S1-S7. In such an embodiment, the method steps are performed by a carbonization system 1000 according to the invention. In more detail, steps S1-S4 are performed by the first loop reactor arrangement 100 of the carbonization system 1000, whereas steps S5-S7 are then performed by the second loop reactor arrangement 200 of the carbonization system 1000.

In step S3 when the slurry flows through the elongated reactor 110; 210 it reacts with the CO₂ dissolved in the slurry as described above. In step S4 the particles are separated depending on particle size by the continuous separator 150; 250. The larger particles continue to flow through the elongated reactor 110; 210 so that they may continue to react with the dissolved CO₂. After being separated the smaller particles exit the loop reactor arrangement 100; 200 at the slurry outlet 160; 260. Optionally, the slurry outlet 160 is in fluid communication with a second loop reactor arrangement 200, in such case the separated particles flow into the elongated reactor 210 of the second loop reactor arrangement 200 in step S5. If the two loop reactor arrangements 100; 200 are in fluid communication with each other the particles are again separated based on particle size in step S6 by the continuous separator 250 in the second loop reactor arrangement 200. The separation done in step S6 can be substantially the same as done in step S4. Hence, in such an embodiment, the second predetermined particle size referred to above in connection with step S6 is the same as the first predetermined particle size referred to above in connection with step S4. In another embodiment, the second predetermined particle size used in step S6 is smaller than the first predetermined particle size used in step S4. In such an embodiment, the particles separated in step S6 typically have a smaller average particle size as compared to the particles separated in step S4. For instance, the second predetermined particle size could be selected based at least partly on desired characteristics, such as size characteristics, of the end products output from the second loop reactor arrangement 200.

Once the particles have been separated from the most downstream loop reactor arrangement 100; 200 they are cooled in step S7. The cooling can for example be performed using the cooler device 310.

Typically, in the feeding step S2, the feeding rate is constant. However, in the beginning of a process or method the feeding rate may be lower. It is also possible to feed just water in the beginning and then start feeding the slurry.

In one embodiment, the method additionally comprises a pressurization and a depressurization step. For example, the slurry can be pressurized in a pressurization step in between the slurry formation step S1 and the feeding step S2, i.e., prior to entering the elongated reactor 110; 210. Depressurization can typically occur in connection with the cooling step S7, either before, after or during the cooling step S7. Typically, the slurry is depressurized prior to exiting the loop reactor arrangement 100; 200. Depressurization can take place in one step, two step, or several steps. More than one step may reduce the risk of water freezing. Optionally, the CO₂ that is vented out during the depressurization step can be reused in the process.

The present invention is not limited to the above-described embodiments. Various alternatives, modifications and equivalents may be used. In particular, all embodiments and aspects may be combined with each other.

1. A loop reactor arrangement for a continuous carbonization process, wherein the loop reactor arrangement comprises:
an elongated reactor comprising:
a reactor outlet opening;
a reactor inlet opening; and
at least one carbon dioxide, CO₂, inlet for gaseous and/or supercritical CO₂;
a slurry inlet for continuous flow of slurry into the elongated reactor;
at least one pump; and
at least one continuous separator comprising:
a continuous separator inlet opening in fluid communication with the reactor outlet opening;
a continuous separator outlet opening in fluid communication with the reactor inlet opening; and
a slurry outlet
wherein the elongated reactor and the particle continuous separator form a loop;
wherein the pump is arranged to pump at least a portion of the slurry at least one lap through the loop; and
wherein the continuous separator is arranged to continuously separate at least part of the particles with a particle size smaller than a first predetermined particle size from the loop reactor arrangement.

2. The loop reactor arrangement according to claim 1, wherein the elongated reactor additionally comprises:
at least one CO₂ sensor; and
at least one CO₂ control unit, wherein the CO₂ control unit is arranged to control the CO₂ level in the elongated reactor.

3. The loop reactor arrangement according to claim 2, wherein the CO₂ control unit is arranged to control inlet of gaseous and/or supercritical CO₂ through the at least one CO₂ inlet based on an output signal generated by the at least one CO₂ sensor and representative of a CO₂ level in the elongated reactor.

4. The loop reactor arrangement according to claim 1, wherein the continuous separator comprises a hydrocyclone.

5. The loop reactor arrangement according to claim 1, further comprising a cooler device in fluid communication with the slurry outlet.

6. The loop reactor arrangement according to claim 1, further comprising at least one temperature regulating device arranged to heat or cool the elongated reactor.

7. The loop reactor arrangement according to claim 1, further comprising a large particle separator arranged to separate large particles with a particle size larger than a third predetermined particle size, wherein the third predetermined particle size is larger than the first predetermined particle size.

8. A carbonization system comprising two or more loop reactor arrangements according to claim 1, wherein the two or more loop reactor arrangements are arranged in a sequence so that a first loop reactor arrangement of the two or more loop reactor arrangements is arranged upstream a second loop reactor arrangement of the two or more loop reactor arrangements, wherein the two or more loop reactor arrangements are in fluid communication with each other.

9. The carbonization system according to claim 8, wherein the slurry outlet of the first loop reactor arrangement is in fluid communication with the slurry inlet of the second loop reactor arrangement.

10. A method for carbonizing minerals using a loop reactor arrangement according to claim 1, or a carbonization system, wherein the method comprises the steps of:
forming a first slurry comprising mineral particles and water;
continuously feeding the first slurry to the elongated loop reactor allowing the mineral particles to react with dissolved CO₂;
flowing the first slurry through the elongated reactor, in which CO₂ is dissolved in a liquid of the slurry; and
separating particles having a particle size below a first predetermined particle size of the first slurry from the elongated loop reactor using the continuous separator; optionally flowing the separated particles into the second loop reactor arrangement of the carbonization system in the form of a second slurry;
optionally separating particles having a particle size below a second predetermined particle size of the second slurry from the elongated reactor of the second loop reactor arrangement by means of the continuous separator of the second loop reactor arrangement; and
cooling the slurry exiting the elongated reactor.
